(19) United States
(12) Patent Application Publication
(10) Pub. No.: US 2005/0055551 A1
(43) Pub. Date: Mar. 10, 2005

(54) Interactive protocol for remote management of access control to scrambled data

(75) Inventors: Claudia Becker, Rennes (FR); Chantal Guionnet, Cesson Sevigne (FR); Andre Codet, Rennes (FR); Pierre Fevrier, Saint Sulpice La Foret (FR)

Correspondence Address: STITES & HARBISON PLLC, 1199 NORTH FAIRFAX STREET, SUITE 900, ALEXANDRIA, VA, 22314, US

(73) Assignee: VIACCESS

(21) Appl. No.: 10/493,021

(22) PCT Filed: Oct. 15, 2002
(86) PCT No.: PCT/FR02/03528

(30) Foreign Application Priority Data
Oct. 19, 2001 (FR) 01 13532

(51) Int. Cl. H04L 9/00

(52) U.S. Cl. 713/171

(57) ABSTRACT

The invention concerns a protocol for remote management, from a broadcasting center (E), of access control to scrambled data, through a descrambling terminal (T) and an access control card or module provided with a security processor (PS). It consists in transmitting (A) from the broadcasting center (E) to at least a receiver set (PR) or the security processor (PS) a control message including input template fields, control applicative data, digital signature, and in subjecting (B) the exchange of action instructions and the replies to said action instructions, between the terminal (T) and the security processor (PS), to a local security protocol inhibiting any local viewing at the security processor (PS)/terminal (T). The invention is applicable to management of broadcasting or distribution of scrambled or encrypted data.

The invention relates to a protocol for the remote management of control of access to encrypted or scrambled information.

Control of access to encrypted information has experienced an unprecedented rise through the advent of network information transmission technologies.

These techniques, whose purpose is to ensure the transmission of information to the greatest number of users, currently make it possible to offer a very large number of services because of the rate of growth in the calculation and memory capacities of integrated circuits, doubling approximately every five years, and, as a consequence, in the power for processing transmitted information.

Techniques of control of access to encrypted information were originally suggested in the context of applications in the transmission and display of information on television receivers for entertainment, information and other purposes.

Such techniques have in particular found application in the system known as “ANTIOPE”, standing for “Acquisition Numerique et Télévisualisation d'Images Organisées en Pages d'Ecriture” (the Digital Acquisition and Television Display of Images Organised as Written Pages), the system known as “TITAN”, standing for “Terminal Interactif de Télétexte à Appel par Numérotation” (Interactive Numbering Called Teletext Terminal), or the system known as “EPEOS”, standing for “Enregistrement Programmé des Emissions sur Ordre des Sources” (the Programmed Recording of Emissions on Order of Sources).

These systems, which use a procedure known as “DIDON”, standing for “Diffusion de Données Numériques” (the Broadcasting of Digital Data), for the broadcasting of information relate to a broadcast videotext system, an interactive videotext system, and a programme forwarding system respectively by the remote control from an emission source of the action of recording by receiving equipment, such as a video recorder.

Application of the access control process to such systems has been proposed. Such an application raises the problem of locking the information upon broadcast, by encryption or scrambling, and then unlocking the encrypted or locked information upon reception having regard to user authorisation criteria and the specific features of the system being controlled.

In particular, an access control system applied to the aforesaid systems has been developed and described in French patent application 79 02995 (2 448 825) made available to the public on the 5^{th} Sep. 1980. In the aforesaid access control system a double key process comprising a service key which is used to lock the information, this key being changed randomly at brief intervals of the order of several minutes, and a so-called subscriber key, which may take several values Ci according to the nature of the subscription, are used. This key also changes randomly at longer intervals, of the order of a month. It is recorded on a subscription medium such as a smart card or a credit card which is inserted into each receiver set.

Special messages are composed when broadcasting and transmitted together with the locked data. These messages make it possible to restore the service key in the receiver set, then to open the electronic lock which locks the transmitted locked information.

Such a process has been the subject of many technological developments, which have given rise to the establishment of standard UTE C90-007 “Conditional Access System for Digital Broadcasting Systems”.

In general, on the basis of the teaching in the aforesaid French patent application, the arrangements adopted in the text of the standard mentioned above relate to the definition of specifications for systems controlling conditional access to scrambled or encrypted information which makes it possible to ensure that television and radio programmes, data viewing services or other types of services are only accessible to users who fulfil very specific conditions and satisfy very specific criteria essentially associated with payment for viewing the aforesaid programmes or services.

With this object such systems make it possible to ensure the remote management of controlling access to scrambled information through a service key transmitted between the broadcasting centre and at least one receiver set. The transmitting centre comprises the module calculating a control word, CW, containing at least the service key, and a module encrypting the control word, CW, using an operating key, SOK. A module generating control messages for access entitlement, ECM messages, containing at least the encrypted control word and control parameters for access entitlement and a module generating management messages for access entitlement, EMM messages, are provided. ECM messages and EMM messages can be multiplexed in the flow of transmitted encrypted information.

Each receiver set comprises at least one terminal for unscrambling the scrambled information and an access control module comprising a security processor (PS) housed for example in an access control card inserted into the terminal. The security processor comprises the operating key, SOK, and access entitlements, stored in secure internal memory, and a de-encryption module, the security processor making it possible to restore the service key from the operating key and the encrypted control word subject to verification of one of the recorded access entitlements, from the control parameters for access entitlement.

Each unscrambling terminal comprises an unscrambling module which can de-encrypt the transmitted scrambled information using the restored service key for use by an authorised subscribing user holding the access control card.

Such systems, which have been developed in the context of the provisions of the aforesaid standard UTE C 90-007, are satisfactory inasmuch as on the one hand the calculations for restoration of the service key and the secrets, the operating key, necessary for performance of these calculations are located in a protected memory zone of the access control card, the operating key never being accessible through external reading, and on the other hand transmission and management of access entitlement stored in the memory of the security processor is rendered wholly independent of access control as such, which is subject to holding the current operating key, in order to permit restoration of the current service key, and then unscrambling of the scrambled data using the latter.

This invention relates to the use of a remote management protocol for controlling access to scrambled information enabling application of the access control process to all types of on-line service, associated in particular with electronic transaction operations, regardless of the nature of the scrambled data transmission.

Another object of this invention is, in particular, the use of a remote management protocol for controlling access to encrypted information of a very high security level, the dialogue between the unscrambling terminal and the security processor, the preferred point of attack by pirates and code breakers, being subjected to a local security protocol.

Another object of this invention is also to provide specific messages, such as EPM messages, constituting messages linking the management of access entitlements and ensuring a link between ECM messages and EMM messages.

Another object of this invention is finally to provide a remote management protocol for access control to scrambled information applied in a great variety of services, such as the secure on-line conduct of electronic transactions through the intermediary of-a return path via the transmission of programmable messages, which will make it possible to process state variables representative of a great variety of situations and environments, regardless of the nature of the service and the transaction in question.

The remote management protocol for controlling access to scrambled information using a service key and transmitted via a network, to which the invention relates, is implemented between a broadcasting centre and at least one receiver set. The transmission of scrambled information is accompanied by a control word containing at least the service key, a control word which has been encrypted using an operating key. This transmission of the cryptogram of the control word is carried out by means of access entitlement control messages, ECM messages, containing at least this encrypted control word and access entitlement control parameters. The ECM messages are transmitted and multiplexed in the flow of scrambled information with the access entitlement management messages, EMM messages. Every receiver set comprises at least one terminal for unscrambling the scrambled information and an access control module provided with a security processor. The security processor comprises the operating key and the entered access entitlements allocated to a subscribing user stored in the protected memory of the security processor makes it possible to restore the service key from the operating key and the encrypted control word subject to verification of the entered access entitlements. Every unscrambling terminal can be used to unscramble the scrambled information using the restored service key for use by an authorised subscribing user.

It is noteworthy in that it comprises at least transmitting a control message comprising data fields forming at least one input template, control applicative data and cryptographic redundancy or a digital signature from the broadcasting centre to at least one receiver set and/or the security processor associated with the latter. The input template includes the security attributes applied to the command applicative data. The cryptographic redundancy or digital signature makes it possible to authenticate and guarantee the integrity of the control message from the security attributes.

It also comprises subjecting the exchange of action instructions and responses to those action instructions between the unscrambling terminal and the security processor to a specific local security protocol which makes it possible to protect against local listening at the unscrambling terminal/security processor interface, to carry out a sequence of tasks constituting the performance of at least one action instruction in a secure way.

The protocol to which this invention relates finds application in remote management of control of access to scrambled or encrypted information transmitted periodically over a network, regardless of the nature of the transmission system used, only the requirements for synchronising the transmission of scrambled or encrypted information, the encrypted control word and the service key associated with the latter, if appropriate the operating key used, having to be satisfied.

This will be better understood from a reading of the description and an examination of the drawings below in which:

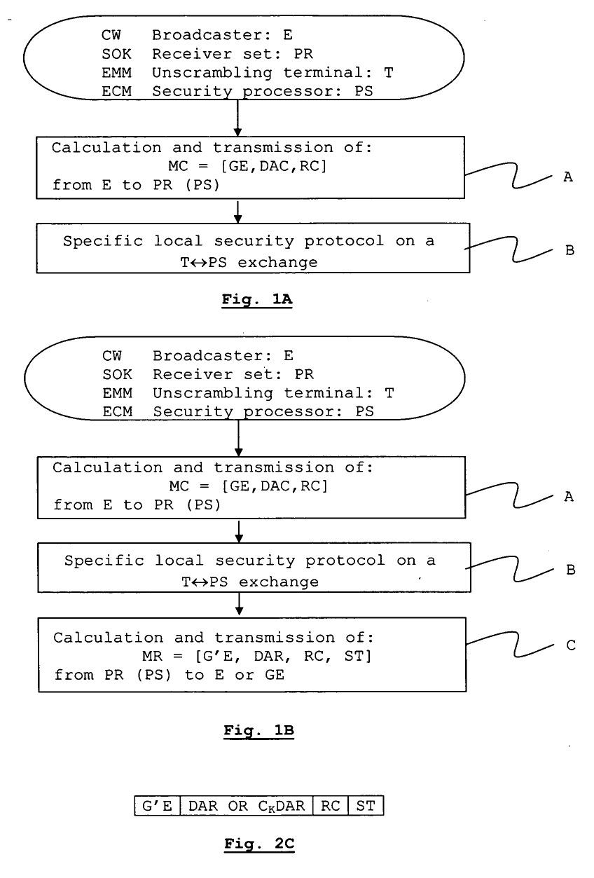

FIG. 1a represents, by way of illustration, an organisation chart of the essential stages in implementing the remote management protocol for controlling access to scrambled information according to this invention.

FIG. 1b represents, by way of illustration, a variant embodiment of the protocol to which this invention relates as illustrated in FIG. 1a, this protocol being of an interactive nature when a return path is present between the receiver set and the broadcasting centre or the management centre of the broadcasting centre.

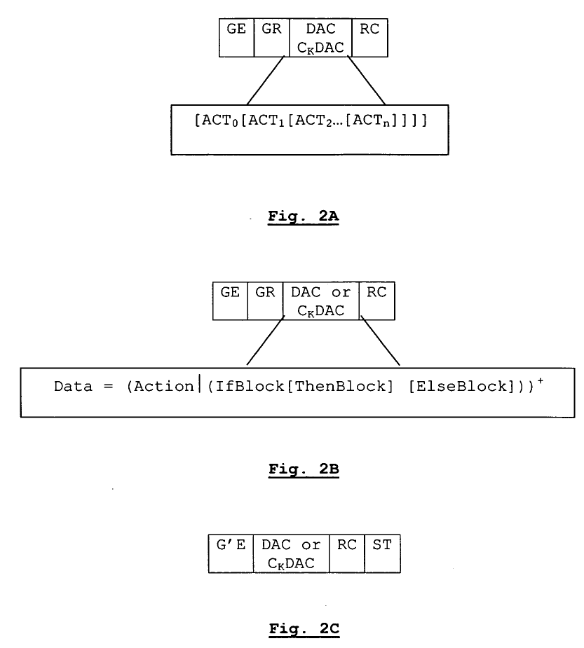

FIGS. 2a to 2c represent, by way of illustration, the specific structure of the reply command messages respectively which make it possible to implement the protocol according to this invention.

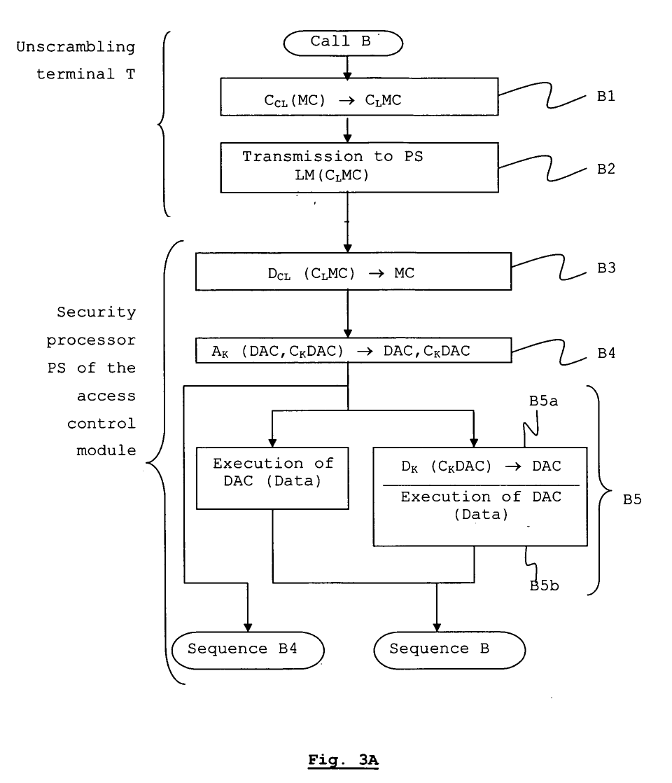

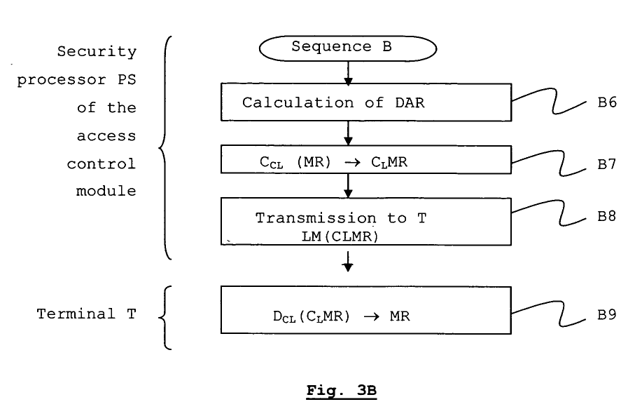

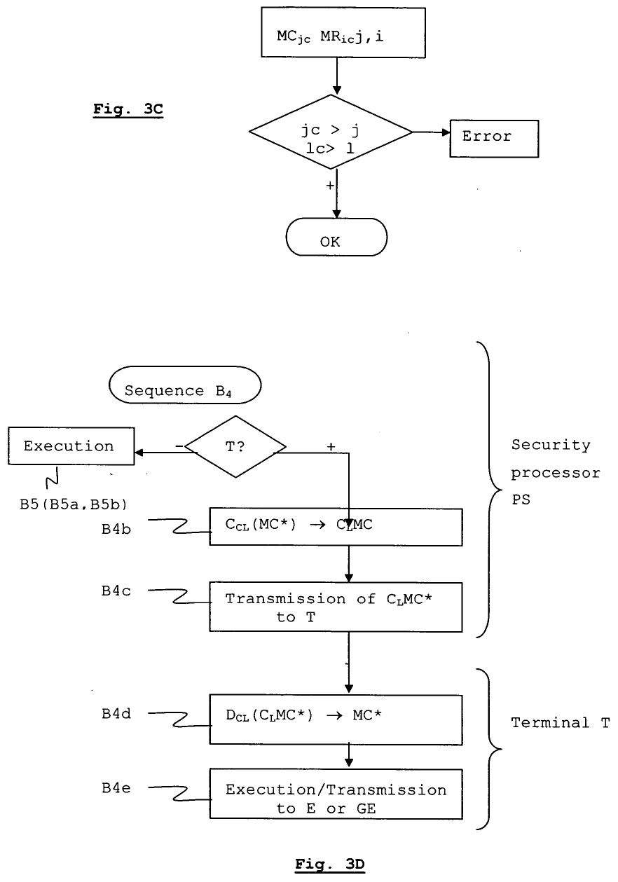

FIG. 3a shows, by way of illustration, an organisation chart of the essential stages which make it possible to implement a local security protocol used between the unscrambling terminal and the security processor with which the access control module associated with the latter is fitted in order to ensure the transmission of command messages towards the secure processor.

FIG. 3b shows, by way of illustration, an organisation chart of the essential stages which make it possible to implement a local secure protocol passed between the security processor with which the access control module is fitted and the unscrambling terminal to ensure the transmission of reply messages to that terminal, if necessary to the broadcasting centre or the broadcasting management centre.

FIG. 3c shows, by way of illustration, a process for indexing reply command messages respectively which can be implemented in the context of the local security protocol in order to increase the security and reliability of the latter.

FIG. 3d shows, by way of illustration, a variant embodiment of the local security protocol shown in FIG. 3a which makes it possible to confer a function controlling the switching of control messages according to their destination, the unscrambling terminal or the security processor itself respectively, upon the security processor of the access control module associated with each unscrambling terminal.

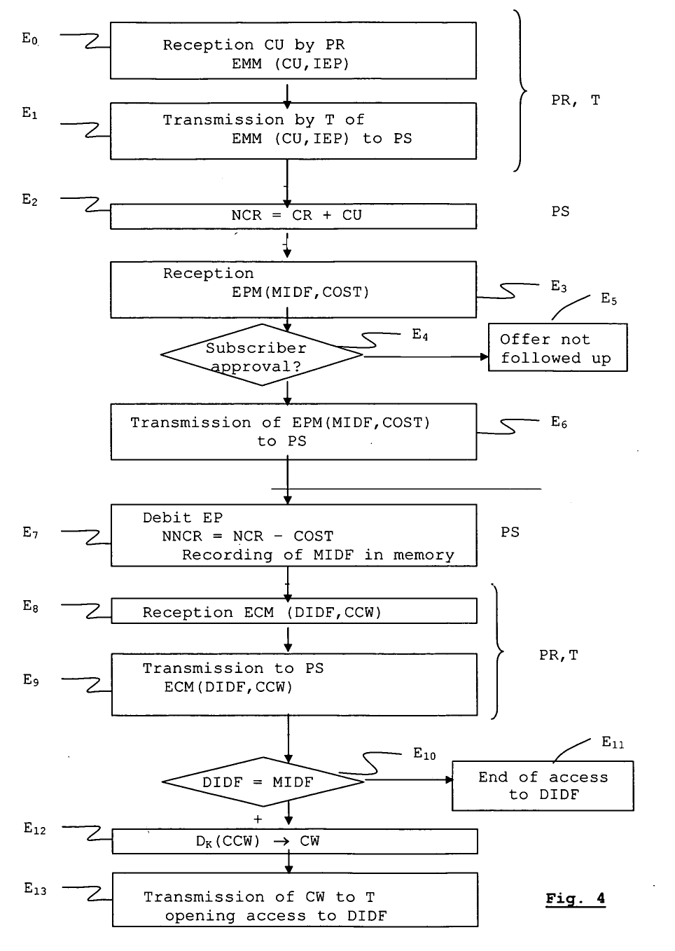

FIG. 4 shows, by way of example, an embodiment of a linking message between an EMM message and a ECM message according to the prior art in an application linked with the use of an electronic token holder.

A more detailed description of the interactive process for the remote management of control of access to scrambled information according to this invention will now be provided in connection with FIG. 1a and subsequent figures.

With reference to the aforementioned FIG. 1a, it should not be forgotten that the process according to this invention is implemented between a broadcaster E, transmitting messages, and a receiver set PR comprising an unscrambling terminal with which an access control module is associated. The access control module is provided with a security processor and may, for example, comprise either an access control card of the microprocessor card type or a virtual card inserted into a more complex system.

Messages transmitted by message broadcaster E are designed to ensure the remote management of access control to scrambled information using a service key and transmitted in a system between the broadcasting centre transmitting E messages and at least one receiver set PR. The concept of scrambling information covers the operations of symmetrical encryption of that information using secret keys and of non-symmetrical encryption using public keys and private keys respectively.

The transmission of encrypted information is accompanied by a control word CW containing at least the service key. The control word is encrypted using an operating key referred to as SOK. Transmission of the encrypted control word takes place using access entitlement control messages referred to as ECM messages containing at least the encrypted control word and access entitlement control parameters.

The ECM messages are transmitted and may be multiplexed in the flow of encrypted information together with access entitlement management messages referred to as EMM messages.

The process of transmitting encrypted data and the multiplexing of ECM messages and EMM messages satisfies for example the provisions of standard UTE C90-007 previously mentioned in the description. For this reason, the aforesaid process will not be described in greater detail.

In general, it should not be forgotten that the access control module associated with each unscrambling terminal T comprises the operating key SOK as well as the entered access entitlements allocated to a subscribing user, who is the authorised holder of the access control module. The operating key and the entered access entitlements are placed in memory in the secure memory of the aforesaid access control module. The latter also comprises a security processor and cryptographic resources which make it possible to restore the service key used to encrypt the transmitted scrambled information, from the operating key and the encrypted control word. Restoration of the service key is brought about following checking of the entered access entitlements, or at least one of the entered access entitlements from the control parameters for the transmitted access entitlements.

Each unscrambling terminal is capable of unscrambling scrambled information broadcast for use in clear by the authorised subscribing user using the restored service key.

Finally, and in the context of implementing the process to which this invention relates, each receiver set can advantageously be connected to the broadcasting centre, broadcaster E, through a return path which ensures interactive implementation of the remote management process according to this invention.

As shown in FIG. 1a, it is indicated that the protocol to which the invention relates comprises at least, in one stage A, transmitting a control message denoted MC=[GE,DAC,RC] comprising data fields forming at least one input template GE, command applicative data DAC and authenticity data RC, which may be a cryptographic redundancy or a digital signature, from the broadcasting centre to at least one receiver set PR and/or to the security processor PS of the access control module associated with the latter.

The input template includes the security attributes which are to be applied to the command applicative data DAC. The authenticity data make it possible to authenticate the command message, as will be described below in the description.

Stage A is followed by a stage B comprising submitting the exchange of action instructions between the unscrambling terminal T and the security processor PS of the access control module to a specific local security protocol. A specific local security protocol can be used to provide protection against local listening at the unscrambling terminal/security processor interface, to carry out a sequence of tasks comprising the execution of at least one action instruction in a secure way.

In accordance with a particularly advantageous aspect of the protocol according to this invention it is pointed out that the specific local security protocol mentioned above implemented in stage B can take into account the destination of the command messages MC to the unscrambling terminal T and the access control module respectively, as will be described below in the description. In fact, depending upon the maximum security requirement sought it is possible to implement different variants for execution of the local security protocol with a view in particular to ensuring maximum security for the exchange of data between the unscrambling terminal T and the security processor of the access control module. The maximum security level may be defined as reserving execution of all the encryption/de-encryption operations to the internal organs of the module, in particular to the security processor of the latter, as will be described below in the description.

Where the receiver set or sets PR are provided with a return path connecting each of these receivers to the broadcasting centre E or to a management centre for the latter GE, aforesaid stage B can then, as shown in FIG. 1b, be followed by a stage C comprising calculating and transmitting a specific reply message to the aforesaid command message MC along the return path. Transmission of the reply message is effected from receiver set PR, that is in fact from unscrambling terminal T, to broadcaster E or as appropriate to the management centre GE associated with that broadcaster and connected to the latter in a network.

In FIG. 1b the reply message is denoted MR=[G′E,DAR,RC,ST].

It comprises data fields comprising at least one input template G′E, reply applicative data DAR and state data denoted ST.

It may also include authenticity data RC. The input template includes security attributes applied to the reply applicative data. According to an advantageous aspect of the protocol to which this invention relates the absence of an input template G′E in the reply message MR corresponds to an absence of the security applied to the reply applicative data. In particular it will be understood that the reply applicative data DAR will not necessarily have been encrypted, depending upon the operation performed, and that as a consequence in such a situation the field or a part of the field of the reply applicative data DAR may be simply transmitted in clear.

On the other hand, when the transmitted command message MC relates to sensitive data, the field or a part of the field forming the command applicative data DAR may be encrypted.

The field containing the authenticity data provided by the cryptographic redundancy or the digital signature RC may be calculated from a signature calculation protocol using for example a public key.

In general, it is pointed out that the specific local security process relates to the exchange of messages between unscrambling terminal T and security processor PS.

In a preferred non-restrictive embodiment the local link between unscrambling terminal T and the access control module, comprising a card, is a link according to protocol ISO 7816. This being the case the exchange of local messages between the unscrambling terminal T and the access control card corresponds to command messages of the type known as C_APDU and reply messages referred to as being of the R_APDU type. The exchange protocol for this type of messages will not be described in detail because it corresponds to a protocol which is in itself known.

Finally, as regards calculation and transmission of reply messages MR, particularly along the return path, it is pointed out that the aforesaid return path may constitute for example a telephone link in the switched telephone system, this link being, as appropriate, being associated with any link in a hertzian network or other conventional type of network in order to ensure the transmission of each reply message MR to broadcaster E or the broadcasting management centre GE associated with the latter.

A more detailed description of the structure of command messages MC and reply messages MR respectively will now be provided in connection with FIGS. 2a, 2b and 2c.

As shown in FIG. 2a, it is pointed out that each command message MC may advantageously include an additional data field comprising a reply template GR. This reply template includes the security attributes which are to be applied to the reply applicative data.

In general it is indicated that each command message MC, where such a command message includes a reply template GR, can be used to fix the security conditions and attributes which have to be applied to the reply applicative data in addition to the command message MC question.

In this way it is possible to manage not only the security of command messages, but also all reply messages by changing the values contained in the field forming the reply template GR for successive command messages MC.

As also shown in FIG. 2a, it is pointed out that in the case of any command message MC the command applicative data DAC or, as appropriate, where these command applicative data are encrypted, these data, referred to in this situation as CKDAC, may comprise an action instruction or, preferably, a list of action instructions.

A list of action instructions is shown in FIG. 2a, this list being referred to as:
[ACT₀[ACT₁[ACT₂ . . . [ACTₙ]]]]

The notation in the aforesaid list of action instructions corresponds to a conventional notation for lists. In particular it will be understood that each action referred to as ACT₀ to ACTₙ may then be executed sequentially by the recipient of the command message MC, this recipient being, in accordance with a particularly advantageous aspect of the process according to this invention, either unscrambling terminal T or the aforementioned security processor of the access control module.

A particularly advantageous way of implementing the process according to this invention will now be described in connection with FIG. 2b.

This embodiment makes it possible to introduce great flexibility into use of the aforesaid messages. In this embodiment the aforesaid messages, command and/or reply messages, then constitute generic messages referred to as EXM. Because of their very great flexibility in use and the structure associated with the latter which makes it possible to introduce such flexibility of use, EXM messages may take the form of ECM messages or EMM messages, or again specific management messages as will be described in the description below.

With this object, as shown in FIG. 2b, the command applicative data and/or reply data are programmable. As a consequence the field corresponding to these data comprises a logical combination of conditions of which the binary result of the logical verification, whether true or false, makes it possible to give rise to the conditional branching of actions. The actions are processed sequentially by the unscrambling terminal T or the security processor PS of the recipient's access control card.

In FIG. 2b, the programmable nature of the command applicative data and/or reply data is shown by the relationship:
Data=(Action|(IfBlock[ThenBlock][ElseBlock]))⁺

In particular, it will be understood that in the above relationship Data refers either to command applicative data DAC in clear, or as appropriate encrypted data designated by C_{K}DAC, or reply applicative data in clear designated by DAR, or as appropriate encrypted data designated as C_{K}DAR. The notation in the above relationship is a metalinguistic description notation of the Backus-Naur-Form type which will be explained in the description below.

As far as the above relationship is concerned, it is pointed out that the command message and/or reply message and the command and/or reply applicative data constitute a structured logic phrase which may include the logical relationship:
If: the condition logic expression is verified,
Then: the action or list of actions described in the action description block or the list of actions associated with the verified condition is executed,
Else: the action or list of actions described in the action description block or the list of actions associated with that unverified condition are executed.

In FIG. 2c the structure of reply messages MR is shown, this structure comprising the input template G′E, the template for the reply applicative data DAR in the form of data in clear or encrypted data C_{K}DAR and the state field ST. It will also not be forgotten that, as far as the reply applicative data DAR in clear or in encrypted form, as mentioned previously, are concerned, these data correspond to the Data data structure as described in connection with FIG. 2a or, preferably, FIG. 2b.

As a result of the structure of the command messages MC and reply messages MR respectively as described above in the description in connection with FIGS. 2a to 2c it is pointed out that the generic EXM messages described above can because of their common structure be dedicated to either commercial management actions which are independent of but associated with the management of access entitlements, commercial actions such as the management of a token holder or the like implanted in the access control module, depending upon the access entitlements entered into the security processor of the access control module, or control of the access entitlements or optimised management of the access entitlements entered in relation, for example, to the behaviour of the authorised subscribing user, or again management of the local security of the exchange of messages between the security processor and the unscrambling terminal through actions providing a link between ECM and EMM messages and secure management actions for encrypted information.

Examples of the general structure of reply command messages respectively are now provided below in the description using a metalinguistic description notation similar to the BNF (Backus-Naur-Form) form in which:
A=BC: element A comprises the sequence of elements B and C,
A=(B)+: element A comprises 1 to n elements B,
A=(B)*: element A comprises 0 to n elements B,
A=B|C: element A comprises element B or element C,
A=B[C]: element A comprises element B optionally followed by element C,
A=−: element A comprises nothing.

A semantic description of the messages will now be provided in the description.

By the term message is meant any command message MC destined for the security processor PS of the module or access control card respectively of terminal T originating from broadcaster E or broadcasting management system GE. For this reason it will be taken that all command messages MC are in fact intended for the security processor equipping either the module or the access control card, whether real or virtual.

All reply messages MR follow a command message MC and have as their destination terminal T or upstream equipment in the transmission system. The general structure of the messages is then as follows, according to Table T1 given below:

TABLE T1
General structure of conditional access messages
In the case of commands:

COMMAND = INPUT TEMPLATE[REPLY TEMPLATE] DATA
AUTHENTICITY

For the responses:

COMMAND = [INPUT TEMPLATE] DATA [AUTHENTICITY]
STATUS DATA

In the case of MC command messages:
a command message comprises an input template and optionally a reply template. The optional reply template describes the security mechanisms which are to be applied to the reply.

The command applicative data are preceded by one or two templates, InputTemplate and ReplyTemplate, only the input template indicating the security attributes used in the present message.

When the command applicative data requires two templates, the latter precede the applicative data in the message.

Preferably, the information described in the input or reply templates of a command message MC are transmitted in clear.

The command applicative data indicate the specific actions which are to be taken into account by the access module or control card or the unscrambling terminal T.

In general, command applicative data are transmitted from distant equipment, i.e. broadcaster E, and are transmitted in encrypted form so as to ensure confidentiality of the data.

In the case of reply messages MR:
the input template G′E includes the security attributes which are applied to the reply applicative data present in the reply. Absence of the template indicates that no security has been applied to the applicative data.

The reply message MR associated with a command message MC may be utilised either locally by unscrambling terminal T or by upstream equipment such as the transmitter or transmitter management system GE through the intermediary of the return path as previously mentioned in the description. In the former case, when reply message MR is utilised locally by terminal T the reply message is not subjected to general encryption, but only to the local security protocol, as will be described below in the description.

On the other hand, when the reply message is intended for transmission along the return path, this reply message MR is subjected to a general encryption process using for example a specific management key.

Of course, reply messages MR may also optionally contain authenticity data, cryptographic redundancy or a digital signature to authenticate and guarantee the integrity of the reply message itself. The field relating to these authentication data is absent when the associated input template is absent.

As far as the state field, designated by ST, is concerned, a reply message MR always includes a state or state field providing a report on the structure of the message, i.e.:
it has not been possible to interpret the message, if the reply only contains the status ST,
the message has been processed, in this case the reply includes the reply applicative data and the status ST.

More specific indications relating to the input template data field of command and reply messages will now be provided.

With reference to the general structure of the messages previously mentioned in the description in connection with Table T1, it will be pointed out that the templates define the parameters necessary for the security mechanisms applied to the command applicative data and reply applicative data respectively.

This being the case, the two input templates GE or G′E and the reply template GR may include the following information, as shown in Table T2:

TABLE T2
Template structure

Template = RefFile [Algolds] Keylds [RefInits]

In the aforesaid table the file reference designated by RefFile indicates the file in which the key references apply. This is the name of a dedicated file or master file, i.e. the name of a service distributed by the broadcaster of encrypted data subject to conditional access. As a general rule, RefFile=SOID. SOID designates a broadcast service identifier parameter, standing for Service Output Identifier in English.

The algorithm references designated Algolds specify the algorithms used in the current message for the cryptographic functions associated with the message as described in Table T3.

TABLE T3
Structure of the algorithm references

Algolds = AlgoAuthenid [AlgoConfid] [AlgoCipherid]

In the above table, AlgoAuthenid indicates the message authenticity function, AlgoConfid indicates the confidentiality function for the reply applicative data and AlgoCipherid indicates the encryption function for the reply command specific applicative data respectively.

The key reference Keyids specifies the keys used in the current message while implementing the functions defined according to Table T4.

TABLE T4
Structure of the key references

Keyids = [KeyAuthenid] [KeyConfid] [KeyCipherid]

In which KeyAuthenid represents the authenticity verification key for the message, KeyConfid indicates the confidentiality key for the reply command applicative data and KeyCipherid indicates the encryption key for the specific applicative data respectively.

The initial data references RefInits are the values used in the current message to initialise the message authenticity functions designated InitAuthen and the confidentiality of the applicative data InitConf respectively.

The general structure of the messages is as a consequence as follows:
without any reply template: where the reply template is not specified in the command message MC, no security mechanism has been applied to the reply,
no template is provided in the reply message MR,
reply applicative data are in clear in the reply message MR,
no authenticity is attached to the data.

The command message MC/reply message MR pair then has the following structure as shown in Table T5:

TABLE T5

| Command message | Reply message |
|---|---|
| Input template (GE) | |
| Data (DAC) or (C_{K}DAC) | Data in clear (DAR) |
| Authenticity (RC) | Status Data (ST) |

With reply template: the structure of the command and reply messages respectively is as follows, as shown in Table T6:

TABLE T6

| Command message | Reply message |
|---|---|
| Input template (GE) | |
| Reply template (GR) | Input template(G'E) |
| Data (DAC) or (C_{K}DAC) | Data (in clear or scrambled) |
| | (DAR or C_{K}DAR) |
| Authenticity (RC) | Authenticity (RC) |
| | Status data (ST) |
| | In bold: The data imposed by |
| | the command reply template |

As a general rule, the provisions applicable to the templates are as follows:
if a function is not necessary the associated security attributes are not explicitly described,
messages containing confidential data and/or encrypted data must include an input template for the message to be authentic.

More specific indications will now be provided relating to the data structures constituting the command and reply applicative data fields respectively.

With reference to the general structure of command and reply messages respectively, it will not be forgotten that the command applicative data for a command message MC include:
either an action or a list of actions processed sequentially by the recipient, i.e. by the security processor of the access control module or the unscrambling terminal T,
or a logical combination of conditions for which the binary result of the verification, whether true or false, makes it possible to carry out conditional branching of the actions which are processed in sequence by the recipient.

It will not be forgotten that the command message, or reply message as appropriate, complies with the structured logic phase and may include the logical relationships:
If:
Then:
Else:
as previously mentioned in the description.

Such a structure may be repeated within a structure of data designated by TData, the combination of conditions and actions being coded on the basis of a TLV coding process according to an ASN.1 data structure with labels of the TData type.

In general, it is pointed out that a single condition is a condition comprising just one action.

A logical combination of conditions comprises at least logical operators such as the conventional operators OR, AND, NOR and NAND carrying out OR, AND, NOT-OR and NOT-AND logic operations.

Depending upon the context of the applicative data processed, unscrambling terminal T is capable of selecting between a long reply and a short reply respectively provided in a reply message MR associated with a command message MC.

The applicative data for a long reply advantageously include:
repetition of the command structure,
for each action requested in the command:
repetition of the action required in the command,
description of the information requested by each action in the command, this information being provided by the card or the terminal,
a report on each action, so as to inform broadcaster E about performance of the action.

The applicative data for a short reply include for each defined action:
a principal single message block or action present in a conditional message without any combination of conditions, or
a then and/or else block present in the command which may or may not have been executed,
a description of the information requested by each action of the block or blocks, this information being provided by the access control card or module or unscrambling terminal T,
a report on each action by the block or blocks in order to inform broadcaster E about the result of execution of the action.

Thus each command message MC may include a field or a bit specifying the reply format of the corresponding reply message associated with the latter. The long or short reply format may be selected by the unscrambling terminal T depending upon the application context and the detail of the information required in the context of that application context. A plurality of reply formats may be provided.

An example of a long or short single command message MC or single reply message MR respectively is provided in Table T7:

TABLE T7

| | Comments |
|---|---|
| Command message | |
| T_{InputTemplate} L_{InputTemplate} | Input template |
| [T_{ReplyTemplate} L_{ReplyTemplate} | Reply template |
| T_{Data} L | Applicative data |
| [T_{SOID} L SOID] | Depending upon whether the |
| [T_{Data} L Data] | structure is optimised or |
| (T_{ActionObject} L Action)* | not. |
| | Ditto. |
| | Action(s) to be performed. |
| T_{Auhen} L Authenticity | Message authenticity |
| Long reply message | |
| [T_{InputTemplate} L InputTemplate | Input template |
| T_{Data} L | Applicative data: |
| [T_{SOID} L SOID] | SOID and/or overall Date, if |
| [T_{Date} L Date] | present in the command. |
| (T_{ActionObject} L Action | Reply to each action in the |
| [T_{Result} L Result] | command. |
| T_{Status} L StatusAction)⁺ | |
| [T_{Authen} L Authenticity] | Message authenticity. |
| T_{StatusData} L StatusData | General status on reply. |
| Short reply message | |
| [T_{InputTemplate} L InputTemplate | Input template |
| T_{Data} L | Applicative data: |
| ([T_{Result} L Result] | Reply to each action in the |
| T_{Status} L StatusAction)⁺ | command. |
| [T_{Authen} L Authenticity] | Message authenticity. |
| T_{StatusData} L StatusData | General status on reply. |

The general structure of the command and reply applicative data respectively makes it possible to code the combination of conditions. Such a structure may be recursive and in this case is represented as shown in Table T8:

TABLE T8
General structure of the applicative data

```
For commands:
    Data = (Action| (IfBlock [ThenBlock] [ElseBlock]))⁺
Where
Action = Action demanded.
        IfBlock = “AndIf” (Ifblock|Action)+|“OrIf”
        (IfBlock|Action)+|“NAndIf” (IfBlock|Action)+|“NOrIf”
(IfBlock|Action)+.
ThenBlock = “Then” (Action)+
ElseBlock = “Else” (Action)+.
For long replies:
Data = ((Action[Result]StatusAction)|(IfBlockR [ThenBlockLR]
[ElseBlockLR]))⁺
Where
Result = Information requested by the action where there is
any.
StatusAction = Report on each action.
IfBlockR = “AndIf” (IfBlockR|(Action [Result]
          StatusAction))+|
          “OrIf” (IfBlockR|(Action [Result]
          StatusAction))+|
          “NAndIf” (IfBlockR|Action [Result]
          StatusAction))+|
          “NOrIf” (IfBlockR [Result] StatusAction)+.
ThenBlockLR = “Then” (Action [Result] StatusAction)+
ElseBlockLR = “Else” (Action [Result] StatusAction)+.
For short replies:
    Data = (([Result] StatusAction)|([ThenBlockSR]
                    [ElseBlockSR]))⁺
Where
Result = Information requested by the action if there is
any.
StatusAction = Report on each action.
ThenBlockSR = “Then” [Result] StatusAction)⁺.
ElseBlockSR = “Else” [Result] StatusAction)⁺.
```

The execution rules are then as follows:
1. In a list of actions, actions are processed in the order in the list.
2. In an AndIf, NAndIf, OrIf or NOrif clause all the actions in the associated list can be evaluated.
3. In an AndIf or NAndIf clause the actions in the associated list are executed as long as the clause is true.
4. In an OrIf or NOrIf clause the last action executed in the associated list is the one rendering the clause true.

By way of a non-restrictive example it is pointed out that the command and reply applicative data respectively carried in a message such as a command message MC or reply message MR respectively may be:
consult O1 or update object O2, O1 and O2 designating objects,
if the controlled actions O1 or O2 are verified, then de-encrypt O3, where O3 indicates by way of a non-restrictive example the cryptogram of the control words CW, i.e. the control words CW encrypted using the operating key SOK.

A more detailed description of the specific local security protocol constituting stage B in FIG. 1a or 1b will now be provided in connection with FIGS. 3a to 3d.

In general it should not be forgotten that the interface between the unscrambling terminal and the security processor of the access control module and in particular the access control card where the latter constitutes for example a microprocessor card is the preferred point of attack for pirates and code breakers when attempting to compromise the control word CW when the latter is transmitted from the security processor PS to the unscrambling terminal T. In fact all the calculations for restitution of the control word CW are performed within the security processor, which has a maximum degree of security, it being possible for the secrets necessary for restitution of the control word to be accessed by external reading.

More particularly it will not be forgotten that the command applicative data in each command message received at the unscrambling terminal T may be in clear or on the other hand may be encrypted and these are referred to as DAC and C_{K}DAC respectively in these two situations.

It will not be forgotten that the encrypted command applicative data C_{K}DAC have been subjected for example to a general encryption process from a specific management key referred to as K available to the authority responsible for the management of access control and, in particular, the broadcasting of for example scrambled data.

In order to implement the local security protocol it is pointed out that the unscrambling terminal T and the access control module, in particular the access control card for example constituting the latter, are provided with cryptographic encryption/de-encryption, calculation and authenticity verification resources. In a simplified way it is pointed out that these cryptographic resources include encryption algorithms and keys respectively for specific calculation and authenticity verification symbolically represented by an encryption/de-encryption, calculation and authenticity verification key referred to as CL. This key is shared locally by each unscrambling terminal and by each access control module and may be specific to each pair so constituted.

This being the case, as shown in FIG. 3a, the specific local security protocol may comprise subjecting at least the command applicative data of the command message MC to a process of local de-encryption and local authentification in B1 at unscrambling terminal T. Preferably all the fields of the command messages MC are submitted to the local security protocol.

In FIG. 3a the corresponding local encryption and local authentification operation is denoted using the relationship:
C_{CL}(MC)→C_{L}MC

In this relationship it is shown that the operation C_{CL} indicates both encryption of at least either the command applicative data in clear, DAC, or the encrypted command applicative data, C_{K}DAC, of the command message MC and calculation of the signature values for example in order to give rise to the corresponding encrypted values and signature values permitting authentification of the values referred to as C_{L}MC for the command applicative data in clear or for the encrypted command applicative data.

According to a particularly advantageous feature of the specific local security protocol to which the invention relates it is pointed out that the local encryption and local authentification process is independent of the encryption process previously used on transmission of the command message, i.e. in particular the general process of encryption using the previously mentioned management key K.

Stage B1 is then followed by a stage B2 comprising transmitting encrypted local command messages formed from locally secure command data C_{L}d MCfrom unscrambling terminal T to the security processor PS of the access control module.

In FIG. 3a encrypted local command messages are referred to symbolically as LM (C_{L}MC). In the case where the access control module comprises a microprocessor access control card transmission to security processor PS in stage B2 may be performed in accordance with protocol ISO 7816, the local command messages being constituted in accordance with messages of the C_APDU type in a way which is in itself known.

The local security protocol then consists of subjecting encrypted local command messages to a process of local de-encryption and local authentification in security processor PS with which the access control module is provided, in a stage B3, in order to restore the applicative data field for the aforesaid command.

The operation performed in stage B3 is denoted:
D_{CL}(C_{L}MC)→MC

In this relationship D_{CL}(.) refers to the aforesaid local de-encryption and authentification operation.

Following stage B3 either command applicative data in clear DAC or command applicative data encrypted according to the general encryption process C_{K}DAC comprising the command message MC are available.

Stage B3 is then followed by stage B4 comprising subjecting the applicative data field to an authentification process to restore suites of action instructions which can be executed in accordance with at least one task from the aforesaid command applicative data field.

It is pointed out that in FIG. 3a the authentification process is denoted using the relationship:
A_{K}(DAC,C_{K}DAC)→DAC, C_{K}DAC

In the above relationship the operation A_{K}(.) indicates the authentification process, which may for example comprise an operation of verifying the signature from the management key K used in the general encryption and authentification process by the operator managing the protocol to which this invention relates and broadcasting of the corresponding service. In fact it is pointed out that this operation may be carried out on the basis of security attributes transmitted with the command message MC, these attributes making it possible to identify and thus restore the management key K stored in the memory of security processor PS.

At the end of stage B4 command application in clear DAC or command applicative data C_{K}DAC encrypted in accordance with the general encryption process are available, as mentioned previously in the description.

When the command applicative data are in clear, DAC data, stage B4 is then followed by a stage B5 consisting of executing the suite of action instructions which can be executed according to a task. The execution is shown in Stage B5, on the left hand side of FIG. 3a.

On the other hand, when the command applicative data are encrypted on the basis of general encryption, C_{K}DAC data, execution stage B5 may as shown on the right hand side of FIG. 3a be subdivided into a first stage B5a comprising performing a decryption of the encrypted command applicative data using the management key K, this operation being denoted using the relationship:
D_{K}(C_{K}DAC)→DAC,

In the relationship mentioned above, DK(.) indicates the operation of decryption proper using management key K. Stage B5a may precede stage B4 or be carried out at the same time.

Stage B5a is followed by a stage B5b of executing the command applicative data DAC.

A more detailed description of the specific local security protocol implemented when establishing reply messages will now be provided in connection with FIGS. 3b to 3d.

With reference to aforesaid FIG. 3b it is pointed out that after the execution of at least one action instruction which can be executed according to at least one task the specific local security protocol comprises calculating the reply applicative data in security processor PS from the execution of at least one action instruction which can be executed in accordance with at least one task in stage B6. It will be understood in particular that the reply applicative data are calculated from state data obtained following execution of the blocks relating to the Then condition of the command applicative data, as well as after the procedure for evaluation of the non-executed blocks where this condition is not verified, but followed by the Else condition as mentioned previously in the description. Furthermore, the reply applicative data DAR may comprise a structured logic phrase containing at least the logic relationship itself applied to specific state variables as previously mentioned in the description.

Stage B6 is then followed by a stage B7 comprising subjecting the reply applicative data DAR to a security process by local encryption and local authentification of the reply message MR to give rise to reply applicative data which have been locally rendered secure.

In stage B7 the abovementioned process is shown symbolically by the relationship:
C_{CL}(MR)→C_{L}MR

In the above relationship, as when implementing stage B1 in FIG. 3a, C_{CL}(.) indicates operation of the security process by local encryption and local authentification in order to obtain secure encrypted data C_{L}MR.

Stage B7 is itself followed by a stage B8 comprising transmitting local reply messages containing locally secure reply applicative data from security processor PS to unscrambling terminal T.

In FIG. 3b the local reply messages containing the reply applicative data which have been locally rendered secure are denoted:
LM(C_{L}MR).

When the access control module comprises an access control card connected to the unscrambling terminal using a local link according to protocol ISO 7816, the aforesaid local reply messages comprise messages referred to as being of the R-APDU type.

The specific local security protocol as shown in FIG. 3b is then followed in unscrambling terminal T by a stage B9 consisting of subjecting the reply applicative data which have been locally rendered secure to a local decryption and local authenticity verification process to restore the original reply applicative data constituting the reply message MR.

In FIG. 3b the corresponding operation is denoted using the relationship:
D_{CL}(C_{L}MR)→MR

In this relationship the operation D_{CL}(.) designates the local decryption and authenticity verification operation performed using the local encryption and authentification key CL.

The local security protocol implemented in respect of the reply message and the reply applicative data DAR as described in connection with FIG. 3b is perfectly satisfactory in the situation where the reply applicative data are only to be sent to unscrambling terminal T. In fact the local security process implemented in stage B7 in particular and, of course, in relation to command messages MC in stage B1 of FIG. 3a, is sufficient to ensure strict confidentiality for local messages exchanged on the local link between the unscrambling terminal and the security processor of the access control module. In fact it is always possible to envisage that strong cryptographic systems may be resorted to in order to implement the local security processes, strong cryptographic systems such as for example disposable masks or others which make it possible to ensure almost perfect encryption of the local messages exchanged on the local link, the target of pirates or code breakers.

Furthermore, the local security protocol may advantageously be accompanied by a process of indexing the command and reply messages so as to strengthen the security and reliability of the whole while allowing filtering or replaying to be detected, and thus the elimination of messages which are accidentally and/or unintentionally repeated by unauthorised persons.

With this aim, as shown in FIG. 3c, a current index value denoted jc or ic respectively for command messages and reply messages is associated with each command or reply message MC, MR respectively, the indexed command and reply messages being denoted MC_{jc} and MR_{ic} respectively. The aforesaid indexes represent the current values of the indexes j and i allocated to each command or reply message respectively. Each value of the current index is incremented for each new command or reply message respectively, this increment being effected locally either in the unscrambling terminal or in the security processor.

The current value is compared with the previous value j or i respectively of the command or reply message index respectively satisfying the abovementioned comparison.

If there is a negative reply to this comparison for the current command or reply message respectively, an error message is created, and a mutual unscrambling terminal/security processor authentification process may for example be initiated.

On the contrary, if the abovementioned comparison results in a positive reply the local security process or protocol may then be continued on the basis of the current command or reply message respectively.

The abovementioned indexing process may for example be implemented subsequently to stage B4 in FIG. 3a in the security processor, prior to execution stage B5 for example.

Finally, a preferred implementation of the local security protocol in which the access control module security processor plays a predominant part in controlling all the command messages received and processed by the unscrambling terminal and/or control access module security processor will now be described in connection with FIG. 3d.

In general it is indicated that the security processor PS is provided with a function of discriminating the destination of the command messages MC in order to ensure full control over the transmission and execution of command and reply messages respectively under the authority of the local security protocol implemented.

With this aim, as shown in FIG. 3d, the local security protocol may comprise subjecting the command applicative data to a destination discrimination test in the access control module or unscrambling terminal respectively in a stage B4a. This operation consists for example of determining whether the command message MC corresponding to the current message or a command-applicative data DAC command of the latter is intended for unscrambling terminal T.

If there is a negative reply to the aforesaid test the command message MC or the command in question being intended for security processor PS and the authentification stage in stage B4 having had a successful outcome, execution according to stage B5 in FIG. 3a may be performed either on the basis of command applicative data DAC or on the basis of encrypted command applicative data C_{K}DAC.

On the contrary, if there is a positive reply to test B4a, the current command message MC or the command in question being intended for unscrambling terminal T, this message being denoted MC*, a local security stage B4b is called, this consisting of subjecting the command applicative data DAC, C_{K}DAC or the command message MC* to a process of local encryption using the local encryption key CL. This operation implemented in security processor PS corresponds to that carried out in stage B1 of FIG. 3a.

Aforesaid stage B4b is then followed by a stage B4c consisting of transmitting encrypted command applicative data or the encrypted command message, i.e. data C_{L}MC*, to unscrambling terminal T, whether these data have been encrypted by means of a general encryption procedure through the use of a management key K or on the contrary have not been subjected to such a general encryption process. In the former case general decryption is performed by security processor PS before transmission to unscrambling terminal T.

Following transmission to terminal T in stage B4c the aforesaid encrypted command applicative data are subjected to a decryption operation in a stage B4d in terminal T itself. This decryption operation substantially corresponds to the operation described in connection with stage B3 in FIG. 3a, this time being implemented in unscrambling terminal T.

Aforesaid stage B4d is itself followed by a stage B4e comprising either execution of the command applicative data in clear DAC in the unscrambling terminal or, on the contrary, transmitting the command applicative data encrypted by the general encryption process, data referred to as C_{K}DAC, to broadcasting centre E or to the centre managing this broadcasting centre GE.

An example of an embodiment of a linking message known as an EPM message between an EMM message and an ECM message of the prior art will now be described in connection with FIG. 4 in an application associated with the use of a token holder or any other value deduction system.

With reference to the aforesaid figure, in a stage E₀ the receiver set PR receives a credit of units CU through an EMM message denoted EMM (CU, IEP). Following receipt of the aforesaid EMM message unscrambling terminal T presents the aforesaid message to security processor PS by transmission, the latter adding the credit of units to the electronic token holder mentioned in message EMM. By way of example it is pointed out that in the case of an electronic token holder EP the identification number may be a number IEP. The aforesaid transmission operation is carried out in stage E₁.

After the abovementioned stage security processor PS adds the credit of units in the electronic token holder mentioned in stage E₂, the crediting operation being denoted:
NCR=CR+CU
where CR designates the previous credit value and NCR designates the new credit value.

Operations E₀, E₁ and E₂ are carried out on the initiative of the access control manager in order to confer a sufficient credit of units to allow the latter to offer access to all customers allocated the aforesaid credit of units.

With this aim stage E₂ is then followed by a stage E₃ which is carried out on the initiative of the access control manager through the transmission and, of course, corresponding reception by receiver set PR of a message referred to as EPM which is designed to ensure the link between the aforesaid EMM message and any subsequent ECM message as will be described below.

The EPM message, in the form EPM(MIDF, COST), broadcasts a film or programme reference number, denoted for example MIDF, which will be broadcast and which the subscriber can accept or reject within the context of the access offer made. In addition to this the aforesaid EPM message comprises a cost value, referred to as COST, corresponding to the purchase cost of the film or programme in question.

Following a stage E₃, a stage E₄ is envisaged which comprises requesting the subscriber's approval of the offer of access so submitted via terminal T. In practice the EPM message is first presented to security processor PS which indicates that the subscriber's approval is necessary.

In the absence of any subscriber approval in stage E₄ the offer of access is classified as being without follow-up in stage E₅. Conversely if the subscriber notifies approval of the aforesaid access offer in stage E₄, terminal T transmits the EPM message with the subscriber's approval, a message linking with the corresponding MIDF and COST fields to security processor PS.

Stage E₆ is then followed in security processor PS by a stage E₇ which consists of debiting electronic token holder EP, this operation being denoted:
NNCR=NCR−COST
the electronic token holder thus being debited by the value COST, i.e. the number of units corresponding to the programme purchased. Furthermore, the identification or reference number of the film or programme purchased, the MIDF number, is entered in the memory of security processor PS. Preceding stage E₇ is then followed by a stage E₈ which is performed when the film or programme purchased through ECM messages of a conventional type is broadcast. The aforesaid ECM messages are received by the receiver set in stage E₈ and in particular by terminal T and are of course accompanied by the cryptogram of the control word CCW and are presented by terminal T to security processor PS by transmission in stage E₉. The identification number for the programme or film broadcast in these two stages is denoted DIDF.

Security processor PS then begins a verification stage E₁₀ consisting of verifying the identity of the identification number of the broadcast film or programme DIDF and the identification number of the programme or film for which access was offered by the EPM message, i.e. the MIDF identification number.

If the reply to aforesaid verification stage E₁₀ is negative a stage E₁₁ terminating access to the broadcast film or programme identified as DIDF is called. On the other hand if there is a positive reply to the aforesaid verification test E₁₀ an operation of decrypting the cryptogram of the control word is carried out, this operation being denoted:
D_{K}(CCW)→CW.

in stage E₁₂, in order to restore the control word CW.

Stage E₁₂ is then followed by transmission of the control word CW containing the service key to unscrambling terminal T in order to open up access to the broadcast programme or film having identification number DIDF.

Finally the invention relates to any software product recorded on a recording medium which can be executed by an information system computer for implementing a remote management protocol for control of access to scrambled information using a service key transmitted in a network between a broadcasting centre and at least one receiver set, each receiver set comprising at least one scrambled information unscrambling terminal comprising an access control module provided with a security processor, this protocol possibly corresponding to stages such as those previously described in connection with FIGS. 1a and 1b.

According to one particularly noteworthy aspect of the software product to which the invention relates, the latter, when executed by a computer, makes it possible to manage the stages comprising transmission of a command message from the broadcasting centre to at least one receiver set and/or to a security processor associated with the latter. As shown in FIGS. 1a and 1b the command message comprises data fields forming an input template GE, command applicative data DAC and authenticity data RC. Input template GE contains the safety attributes applied to command applicative data DAC. The authenticity data make it possible to authenticate and guarantee the integrity of the command message from the security attributes.

It can then manage a step comprising submitting the exchange of action instructions between the unscrambling terminal and the security processor to a specific local security protocol designated by B in FIGS. 1a and 1b, making it possible to provide protection against local listening at the unscrambling terminal/security processor interface, in order to perform a sequence of tasks constituting the execution of at least one action instruction in a secure way.

The software product recorded on a recording medium which can be executed by a computer in an information system according to the invention also makes it possible to manage the stages of the local security protocol as illustrated and described previously in connection with FIGS. 3a to 3d.

1. Remote management protocol for control of access to information scrambled by means of a service key and transmitted in a network between a broadcasting centre and at least one receiver set, transmission of said scrambled information being accompanied by a control word (CW) containing at least the said service key, this control word being encrypted using an operating key (SOK), transmission of the said encrypted control word being performed by means of access entitlement control messages, ECM messages, containing at least the said encrypted control word and access entitlement control parameters, the said ECM messages being transmitted and multiplexed in the flow of scrambled information together with access entitlement management messages, EMM messages, each receiver set comprising at least one unscrambling terminal for the scrambled information comprising an access control module provided with a security processor, the said security processor incorporating the said operating key (SOK) and recorded access entitlements allocated to a subscribing user stored in the protected memory of this security processor and making it possible to restore the service key from the said operating key and the said encrypted control word subject to the requirement that the said recorded access entitlements are verified on the basis of access entitlement control parameters, each unscrambling terminal making it possible to unscramble the said scrambled information using the restored service key for use by an authorized subscribing user, characterized in that the said protocol comprises at least:
transmitting a command message from the broadcasting centre to at least one receiver set and/or the security processor associated with the latter, this command message comprising data fields forming at least one input template, command applicative data and authenticity data, the said input template containing security attributes applied to the said command applicative data, the said authenticity data making it possible to authenticate and guarantee the integrity of the said command message from the said security attributes,
subjecting the exchange of action instructions and replies to these action instructions between the unscrambling terminal and the security processor to a specific local security protocol providing protection against local listening at the scrambling terminal/security processor interface, in order to execute a sequence of tasks constituting the execution of at least one action instruction in a secure way.

2. Protocol according to claim 1, characterized in that where each receiver station is connected to the broadcasting centre or to a centre managing that broadcasting centre by a return path, the protocol also comprises calculating and transmitting a reply message specific to the command message on that return path, this reply message incorporating data fields forming at least one input template, reply applicative data and state data, the said input template containing the security attributes applied to the reply applicative data, the absence of any input template in the said reply message corresponding to an absence of security applied to the reply applicative data.

3. Protocol according to claim 1, characterized in that each command message also comprises a data field forming a reply template, the said reply template containing the security attributes which are to be applied to the reply applicative data.

4. Protocol according to any claim 1, characterized in that when the said command applicative data are encrypted the said encrypted command applicative data are subjected to a decryption and authentification process and in that the reply applicative data are encrypted and authenticated.

5. Protocol according to any claim 1, characterized in that in respect of any command message the said command applicative data comprise an action instruction or a list of action instructions processed in sequence by the recipient of the command message, the terminal or security processor of the access control module.

6. Protocol according to claim 1, characterized in that the said command applicative data and/or reply data are programmable and comprise a logical combination of conditions whose binary result of the logic verification, true or false, makes it possible to bring about conditional branching of actions, the said actions being processed in sequence by the recipient unscrambling terminal or security processor.

7. Protocol according to claim 6, characterized in that the said command message and the said command applicative data constitute a structured logic phrase containing the logic relationship:
If: the condition logic expression is verified,
Then: the action or list of actions described in the action description block or the list of actions associated with the verified condition is executed,
Else: the action or the list of actions described in the action description block or list of actions associated with this non-verified condition is executed.

8. Protocol according to claim 7, characterized in that the non-executed block is also evaluated.

9. Protocol according to claim 6, characterized in that the said command and/or reply messages are dedicated to:
commercial management actions which are independent of but associated with the management of access entitlements, commercial actions such as the management of an electronic token holder implanted in the said security processor, on the basis of access entitlements recorded in that security processor,
control of access entitlements,
optimized management of recorded access entitlements in relation to the behavior of authorized subscribing users,
management of local security in the exchange of messages between security processors and the unscrambling terminals,
linking actions between ECM messages and EMM messages,
actions managing the security of scrambled information.

10. Protocol according to claim 1, characterized in that, for a command message comprising at least one field of command applicative data the said unscrambling terminal and the said security processor comprising encryption/decryption cryptographic, calculation and authenticity verification resources, the said specific local security protocol comprises:
in the said unscrambling terminal
subjecting the said command applicative data in the said command message to a process of local encryption and local authentification independent of the encryption process previously used for transmission of the said command message to give rise to command data rendered locally secure,
transmitting local encrypted command messages formed from the said command data locally rendered secure to the said security processor, and
in the said security processor
subjecting the said encrypted local command messages to a process of local decryption and local authentification to restore the said command applicative data field,
subjecting the said command applicative data field to a process of authentification and restoring the sequences of action instructions which can be executed in accordance with at least one task from the field of command applicative data,
executing the said sequence of action instructions which can be executed according to at least one task.

11. Protocol according to claim 1, characterized in that the said unscrambling terminal and the said security processor comprise encryption/decryption cryptographic, calculation and authenticity verification resources, the said specific local security protocol also comprising following the execution of at least one action instruction which can be executed according to at least one task:
in the said security processor
calculating the reply applicative data from the execution of at least one action instruction which can be executed in accordance with at least one task,
subjecting the said reply applicative data to a process of rendering them secure through local encryption and local authentification in order to give rise to locally secure reply applicative data,
transmitting local reply messages containing reply applicative data which have been locally rendered secure to the said unscrambling terminal, and
in the said unscrambling terminal
subjecting the said reply applicative data which have been rendered locally secure to a process of local decryption and local authentification verification to restore the said reply applicative data constituting the said reply message.

12. Protocol according to claim 11, characterized in that in the case of reply messages which are intended for the broadcasting centre or a centre managing that broadcasting centre, it also comprises a stage comprising subjecting the reply applicative data to a general encryption and authentification process to give rise to encrypted reply applicative data, the said stage being performed prior to the stage comprising subjecting the said reply applicative data to a process of local encryption and local authentification.

13. Protocol according to claim 9, characterized in that the said process for local security also comprises a process for indexing the command and reply messages which can be used to detect filtering or replaying.

14. Protocol according to characterized in that for a command message comprising at least one command applicative data field the said unscrambling terminal and the said security processor having encryption/decryption cryptographic, calculation and authenticity verification resources, the specific local security protocol comprises at least:
in the said security processor
subjecting the said command applicative data to a test discriminating their destination to the security processor or unscrambling terminal respectively, and
when command applicative data in clear are intended for the said security processor,
executing the said sequence of actions instructions which can be executed according to at least one task; or,
if the command applicative data in clear are intended for the unscrambling terminal,
subjecting the said command applicative data to a process of local encryption and local authentification to give rise to command applicative data which have locally been rendered secure,
transmitting the said command applicative data which have been locally rendered secure from the said security processor to the said unscrambling terminal, and
in the said unscrambling terminal,
subjecting the said command applicative data which have been locally rendered secure to a process of local decryption and local authentification to restore the said command applicative data and constitute the sequences of action instructions which can be executed according to at least one task,
executing the said action instructions which can be executed according to at least one task.

15. Protocol according to claim 1, characterized in that the said local security protocol is executed by symmetrical encryption/decryption based on a local encryption/decryption and authentification key specific to each unscrambling terminal/security processor pair, the said local encryption/decryption and authentification key being parametered from a secret specific to the said security processor and/or the said unscrambling terminal in the said pair.

16. Protocol according to claim 15, characterized in that the said local encryption/decryption and authentification key is modified periodically.

17. Protocol according to claim 1, characterized in that each command message comprises a field specifying the format of the corresponding reply message on the basis of a long or short reply format depending upon the application context and the detail of the information required in the context of that application context.

18. Command message issued from a broadcasting centre to at least one receiver set, this receiver set comprising at least one terminal for unscrambling scrambled information and one access control module provided with a security processor acting together with the said unscrambling terminal through the exchange of local command and reply messages respectively on a local unscrambling terminal/security processor link, characterized in that the said command message comprises at least:
one data field comprising the input template,
one command applicative data field intended to command the said unscrambling terminal and/or said security processor through the intermediary of the said local command messages,
an authenticity data field, the said input template containing security attributes applied to the said command applicative data and the said authenticity data making it possible to authenticate the said command message.

19. Command message according to claim 18, characterized in that it also comprises a data field forming a reply template, the said reply template containing security attributes which are to be applied to the reply applicative data established in reply to the said command message.

20. Reply message transmitted from a command message receiver set to a centre broadcasting these command messages, the receiver set comprising at least one terminal for the unscrambling of scrambled information and an access control module provided with a security processor acting together with the said unscrambling terminal by the exchange of local command and reply messages respectively on a local unscrambling terminal/security processor link, characterized in that the said reply message comprises at least:
one data field forming an input template,
one state data field, the said input template comprising security attributes which are to be applied to the reply applicative data, the absence of an input template in the said reply message corresponding to an absence of security applied to those reply applicative data.

21. Command or reply message respectively according to claim 18, characterized in that the said command or reply applicative data respectively are programmable, the command or reply applicative data field respectively comprising a logical combination of conditions for which the binary result of the logical verification, true or false, makes it possible to give rise to the conditional branching of actions, the said actions being processed in sequence by the said unscrambling terminal and/or the said security processor respectively by the said recipient broadcasting station.

22. Software product recorded on a recording medium and executable by a computer of an information system for implementing the protocol for remote management of control of access to scrambled information using a service key and transmitted within a network between a broadcasting centre and at least one receiver set, each receiver set comprising at least one terminal for unscrambling the scrambled information comprising an access control module provided with a security processor according to claim 1, characterized in that when executed by a computer the said software product generates stages comprising:
transmitting a command message from the broadcasting centre to at least one receiver set and/or to a security processor associated with the latter, this command message comprising data fields forming at least one input template, command applicative data and authenticity data, the said input template containing the security attributes applied to the said command applicative data, the said authenticity data making it possible to authenticate and guarantee the integrity of the said command message from the said security attributes;
transmitting the exchange of action instructions and replies to those action instructions between the unscrambling terminal and the security processor to a specific local security protocol making it possible to protect against local listening at the unscrambling terminal/security processor interface in order to execute a sequence of tasks constituted by the execution of at least one action instruction in a secure way.

23. Command or reply message respectively according to claim 20, characterized in that the said command or reply applicative data respectively are programmable, the command or reply applicative data field respectively comprising a logical combination of conditions for which the binary result of the logical verification, true or false, makes it possible to give rise to the conditional branching of actions, the said actions being processed in sequence by the said unscrambling terminal and/or the said security processor respectively by the said recipient broadcasting station.
